(19) United States
(12) Patent Application Publication
(10) Pub. No.: US 2008/0158920 A1
(43) Pub. Date: Jul. 3, 2008

(54) System and method for charge pump switchover

(76) Inventors: Mark W. Hastings, Weatherford, TX (US); Mahlon D. Kimbrough, Sherman, TX (US); James J. Gainer, Keller, TX (US); Thomas Zoltek, Coppell, TX (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/646,199

(22) Filed: Dec. 27, 2006

(51) Int. Cl. H02M 3/335

(52) U.S. Cl. 363/60

(57) ABSTRACT

An energy storage system and corresponding method, provides an efficient use of stored energy and more regulated power to an output terminal in the event of an interruption in line input power. In one embodiment, an energy storage system has a pulse width modulation (PWM) DC-DC converter module configured to convert line input power to a first regulated output at an output terminal. A pump storage module is coupled to the PWM DC-DC converter module at the output terminal and stores energy from the first regulated output and converts the stored energy to a second regulated output. The energy storage system has a logic unit coupled to the converter module to cause the converter module and pump storage module to transition power at the output terminal from the first regulated output power to the second regulated output power in an event of interruption in the line input power.

### BACKGROUND OF THE INVENTION

Remotely powered devices are devices to which a power source located some distance away provides power through the use of power transmission wires. When the remotely powered device's load demands are low or average, the power transmission wires are capable of delivering sufficient current and voltage. During peak load demand periods, the power transmission wires may not be capable of delivering sufficient power because of, among other things, power losses in the transmission wires and the power source's power supplying limits. To counteract these limitations, remotely powered devices are often provided with energy storage systems that store energy during low and average load demand periods and supply energy to the remotely powered devices during peak load periods.

A specific type of remotely powered electronic device is known as an optical network unit (“ONU”). An ONU is a device that is used as an interface between fiber optic telecommunication lines and traditional wires used to provide telecommunication services such as cable television and telephonic services to homes or other buildings. The ONU has a power supply that typically includes: (i) input protection and filter circuitry; (ii) energy storage circuitry, (iii) input voltage monitors and threshold circuitry, (iv) D.C. to D.C. power converters; (v) ringing generators; and (vi) alarm and digital interface circuitry.

Power is supplied to the ONU from a central location through thin telephone wires. As a result, the available peak power is extremely limited. At an ONU, the load current demand varies depending on the customers' telecommunication service usage. Peak loads occur, for example, when phone sets ring or when a coin-phone executes a coin-collection operation. The peak power requirement is substantially higher than the average requirement and typically exceeds the available power supplied over the power transmission wires.

A few storage methods help meet the peak power requirement. In the past, batteries have been used for energy storage. Batteries, however, have limited service life and require periodic maintenance. They are not well accepted for use with modern remote telephone equipment.

Other methods include the use of a very large storage capacitor C to provide the energy storage, such as a 200V, 8000 uF capacitor. When this method is used with an ONU, a capacitor is coupled across the input terminals of the ONU and is charged up, when the load conditions are low or average, to the input line voltage of typically 90V to 190V. During a peak load event, the input powering line will supply some of the power while the storage capacitor supplies a substantial portion of the load power by discharging its stored energy.

### SUMMARY OF THE INVENTION

An energy storage system, or a corresponding method, provides an efficient use of stored energy and more regulated power to an output terminal in the event of an interruption in line input power. In one embodiment, an energy storage system has a pulse width modulation (PWM) DC-DC converter module configured to convert line input power to a first regulated output at an output terminal. A pump storage module is coupled to the PWM DC-DC converter module at the output terminal and stores energy from the first regulated output and converts the stored energy to a second regulated output. The energy storage system has a logic unit coupled to the converter module to cause the converter module and pump storage module to transition power at the output terminal from the first regulated output power to the second regulated output power in an event of interruption in the line input power.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a network in which an embodiment of the present invention may be deployed;

FIG. 2 is a block diagram illustrating the data and power transmission connections between a central location and an Optical Networking Unit (ONU) in which an embodiment of the present invention may be deployed;

FIG. 3A is a block diagram of an energy storage system of an embodiment of the present invention;

FIG. 3B is a block diagram of an energy storage system of an embodiment of the present invention wherein a pump storage module is used as an alternative power source;

FIG. 4A is a simplified normal buck converter that may be used in connection with embodiments of the present invention;

FIG. 4B is a simplified normal buck and boost converter that may be used in connection with embodiments of the present invention;

FIG. 5 is a more detailed circuit diagram including components of an energy storage system an embodiment of the present invention;

FIG. 6 is a signal diagram illustrating the operation of a system according to a principles of the present invention;

FIG. 7 is diagram illustrating the switching operation of the system corresponding to the signal diagram illustrated in FIG. 6; and

FIG. 8 is a flow chart that illustrates a method of storing and providing energy according to principles of the present invention.

### DETAILED DESCRIPTION OF THE INVENTION

A description of example embodiments of the invention follows.

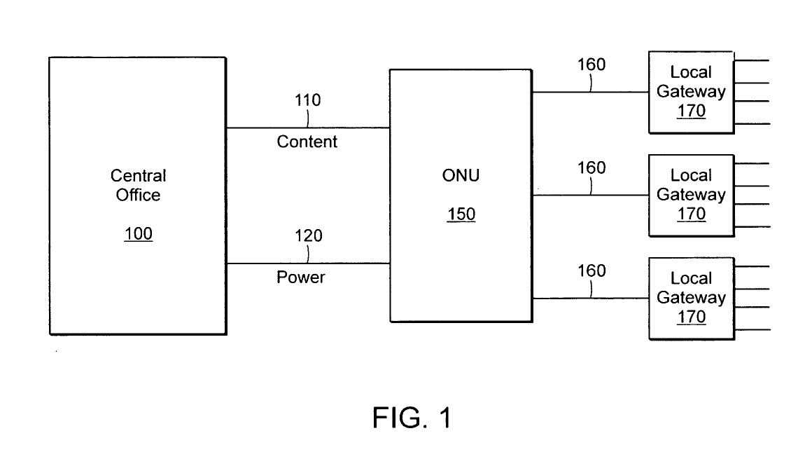

FIG. 1 is a block diagram of a network in which an embodiment of the present invention may be deployed. A central office 100 provides content 110 to an optical networking unit 150 (ONU) for distribution of data services through various connections 160 to local gateways 170. In addition, the central office 100 supplies power 120 to the ONU 150. Both content and power may be sent from the central office 100 to the ONU 150 through a pair of copper wires called twisted-pair wires. Existing access networks typically include numerous twisted-pair wire connections between a plurality of user locations and a central office switch.

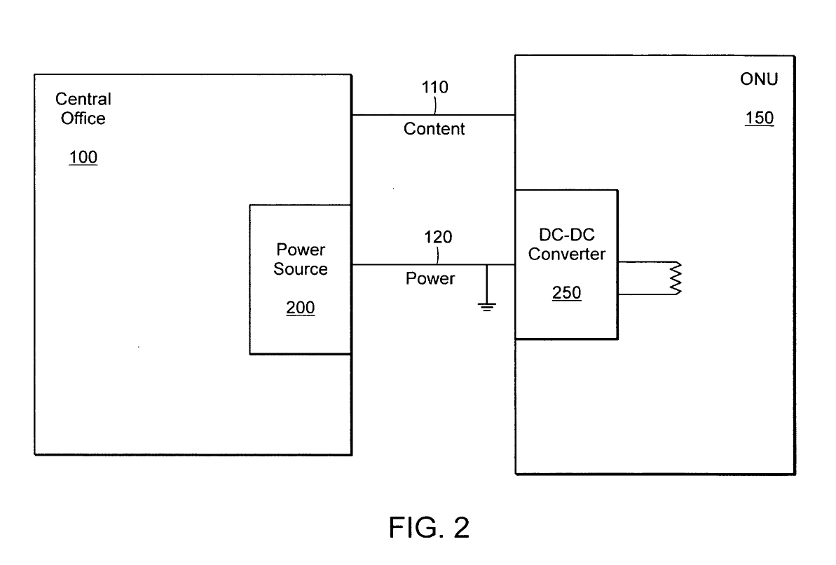

FIG. 2 provides more focused illustration of the data and power transmission connections between a central location and an Optical Networking Unit (ONU) in which an embodiment of the present invention may be deployed. At a central office 100, a power source 200 may reside. In FIG. 2, the power source 200 is a DC power source, but the system could be employed with an AC power source rectified to DC. Typically, the power source 200 would provide a line voltage of 90V to 190V. However, in the event of a lighting strike or energy surge that may trip a ground fault interruptor (GFI) in the line input, that power source may no longer be available. As an example, tripping the GFI may result in a 200 msec power drop out. During the interval of time where this line input power has dropped out, the ONU still requires power in order to continue functioning.

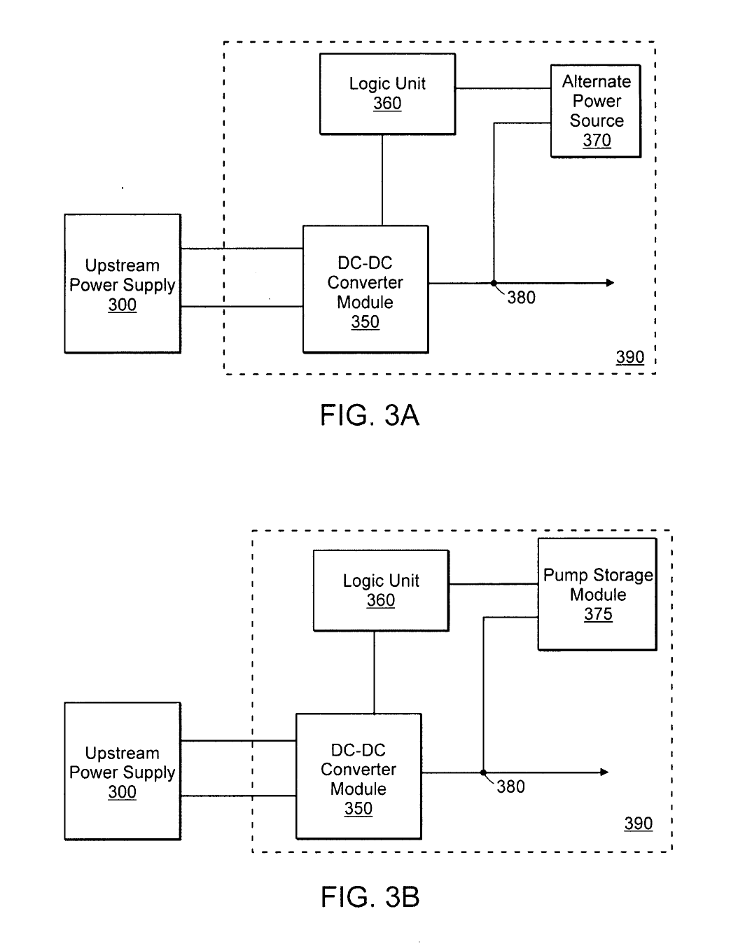

FIG. 3A is a block diagram of an energy storage system of an embodiment of the present invention. The power supply 300 provides power on transmission lines 120A and 120B to a remotely powered device 390. In the illustrated embodiment, the power source is a DC power source. The transmission lines 120A and 120B connect to a Pulse Width Modulation (PWM) DC/DC converter module 350 that converts the line input power to a first regulated output at an output terminal 380. The DC-DC module 350 is also connected to an alternate power source 370, such as a pump storage module, through a logic unit 260. The alternate power source may store energy from the regulated line input power provided by the DC-DC converter module 350. As discussed in more detail below, the logic unit 360 provides control to transition power at the output terminal from the DC-DC converter module 350 to a second regulated output power from the alternate power source 370 in the event of some interruption in the line input power from the upstream power supply 300. An interruption might result from any number of events, including a voltage surge from a lighting strike to the system. The alternate power source may also provide power during peak load periods.

FIG. 3B is illustrates the block diagram of an energy storage system of FIG. 3A wherein a pump storage module is used as an alternative power source. Again, the power supply 300 provides power on transmission lines 120A and 120B to a remotely powered device 390. The transmission lines 120A and 120B connect to a Pulse Width Modulation (PWM) DC/DC converter module 350 that converts the line input power to a first regulated output at an output terminal 380. The DC-DC module 350 is also connected to a pump storage module 375, through a logic unit 260. The pump storage module 375 stores energy from the regulated line input power provided by the DC-DC converter module 350. The logic unit 360 provides control to transition power at the output terminal from the DC-DC converter module 350 to a second regulated output power from the pump storage module 375 in the event of some interruption in the line input power from the upstream power supply 300. Like the alternate power source 370 in FIG. 3A, the pump storage module 375 may also provide power during peak load periods

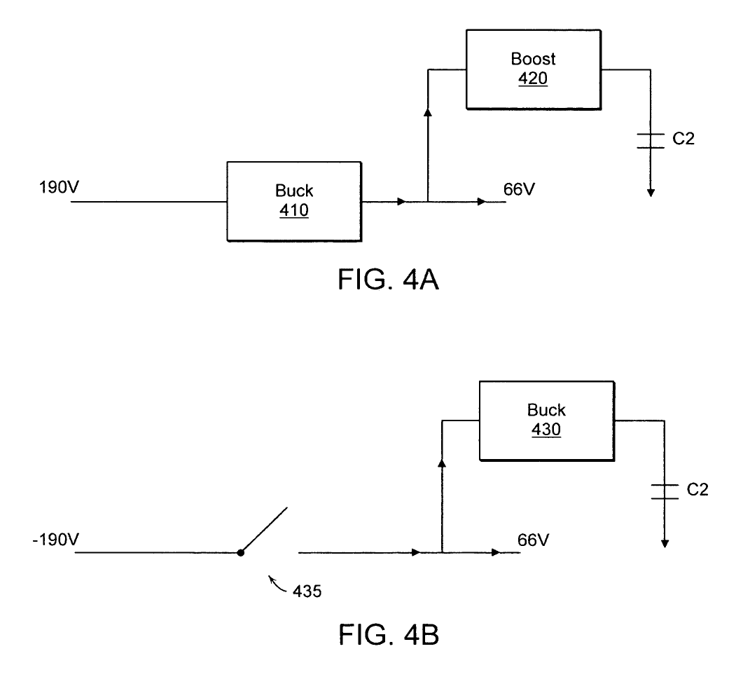

FIG. 4A is a block diagram illustrating circuit functionality at an alternate power source during normal operations. During normal operations, the line input is providing 190V to buck converter 410 to provide a Vₒᵤₜ of 66V. Meanwhile, a boost converter 420 boosts the voltage to a large storage capacitor C2 to store energy from Vₒᵤₜ. is located at one side of a buck converter 410.

FIG. 4B is a block diagram illustrating the circuit functionality at an alternate power source during a line input interruption. Instead of a buck converter 410 of FIG. 4A, an open switch 435 illustrates that the line input no longer provides input power. The system now operates with a buck converter 430 that allows C2 to provide a Vₒᵤₜ of 66V.

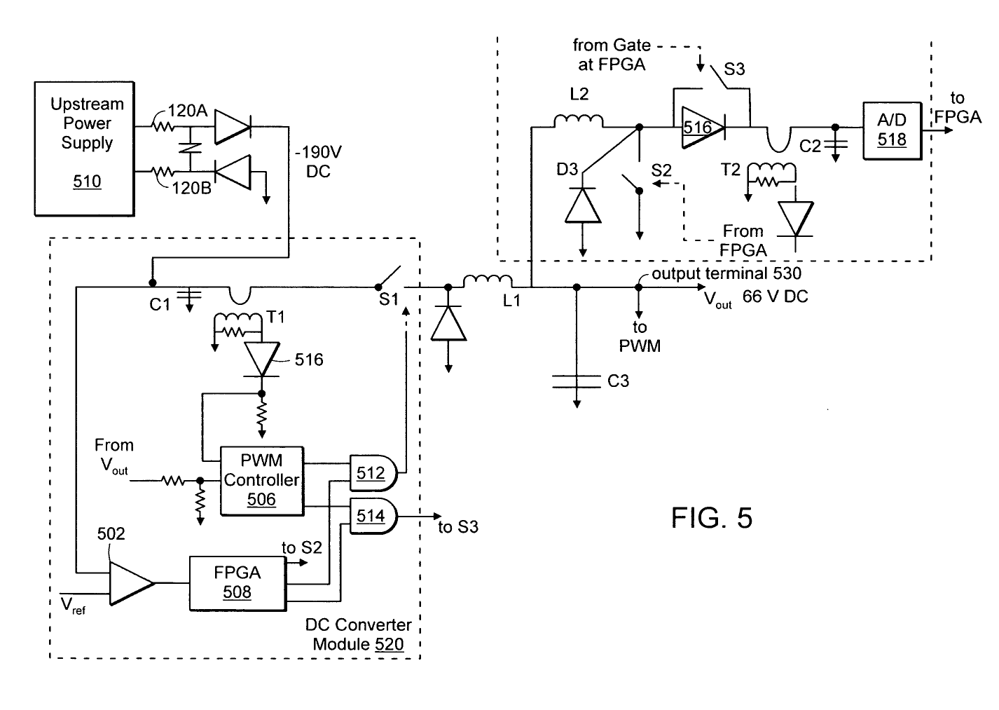

FIG. 5 is a circuit diagram including components of an energy storage system according to an embodiment of the present invention. An upstream power supply 500 provides line input power to the system through a DC-DC module 520. The DC-DC module 520 provides Vₒᵤₜ to an output terminal 530 through switch S1 coupled to an inductor L1. With single input power supply 500, switch S1 is used to switch power to an inductor L1 or transformer, on and off at a high rate, for example, in an ONU, this rate may be roughly 250 KHz. The timing of that switching determines the output voltage of the supply and is controlled by the output of a voltage mode controller, such as pulse modulation width (PWM) controller 506. PMW controller 506 controls the switching based on the Vₒᵤₜ at the output terminal 530 and varies the timing to keep the output voltage constant.

A voltage mode controller looks at only the output voltage to determine the pulse timing. A comparator 502, looks at the output voltage and the peak current flowing through the switch S1. The comparison is provided to a processor, such as FPGA 508. In other embodiments, the processor may also include reprogrammable logic. The comparator 502 and FPGA 508 provide logic for current mode control. Using the current mode control greatly improves the response of the DC-DC converter module 520 to input voltage variations.

While the input voltage is normally supplied, the FPGA provides a signal to logic gate 512, allowing the PWM controller to operate switch S1. The switching of S1 may operate as the buck converter 410 in the system shown in FIG. 4A. In addition, the FPGA also operates to control switch S2 at an alternate power supply 570. S2 may operate as a boost converter 420 as described with respect to FIG. 4A. In a normal operation, S2 remains in an “on” position and serves as a “boost” converter, while switch S3 remains in an “off” position. During normal operation, where the Vₒᵤₜ is stabilized, capacitor C2 stores energy from the regulated output. An analog/digital converter 518 converts the modulated input current and feeds the digital signal back to the FPGA 508. S2 is pulsed slowly in order to allow the charge inductor L2 to provide long time to dump energy into C2. This “soft start” allows C2 to charge slowly to prevent a sudden charge overload of C2.

If the comparator 502 detects an interruption in the line input, the FPGA 508 transitions power at the output terminal 530 from the first regulated output power of the input line to the second regulated output from the alternate power source C2. The FPGA 508 does this by switching S2 into an “off” position, and controlling the signals to logic gate 512 and logic gate 514. This allows PWM controller 506 to control the switching of S3 at a high rate to switch power to an inductor L2, much like switch S1 is used to switch power to an inductor L1. With S2 in an “off” position, and S3 switched off and on, S3 and repeater 516 function as a buck converter 430 as described with respect to FIG. 4B, sending the stored power from capacitor C2 through inductor L2 to the output terminal 530. When there is an interruption in the line input, the circuitry as viewed from S1 may functionally operate as an open circuit as shown with respect to switch 435 in FIG. 4B. As shown in FIG. 5, the pump storage module circuit components at L2 are substantially the same as the converter circuit components from L1 as viewed from the output terminal. This similarity in the circuitry may make it easier to operate the control loops for PWM controller 506.

As the line input current is decreased from the interruption, the FPGA 508 and PWM controller 506 modify the duty cycle of the switching to maintain the peak current level between both the power originating from the line input and the power originating from the alternate power supply.

Simply connecting the storage capacitor to the input of the power supply would require that the input voltage be disconnected simultaneously. The easiest way to do this is with a diode but now the diode is causing extra power loss. According to principles of the present invention, the storage capacitor C2 is connected to the output terminal 530 of the power supply, prevent the extra power loss, and allowing the capacitor to slowly store from the power supply during normal operations. Further, by connecting to the output of the power supply, there is no need for additional current limiter circuitry that is often used to shield alternate power supplies from power surges, such as lightning strikes to the system.

After a period of time where the line input no longer provides sufficient input power, the FPGA 508 will disconnect S1 from the PWM controller 506 and the power provided to the output terminal 530 through S3 from C2. When the comparator 502 detects that line input is restored, the FPGA 508 and PWM controller 506 transition the power to the output terminal from S3 back to S1, and resume normal operations.

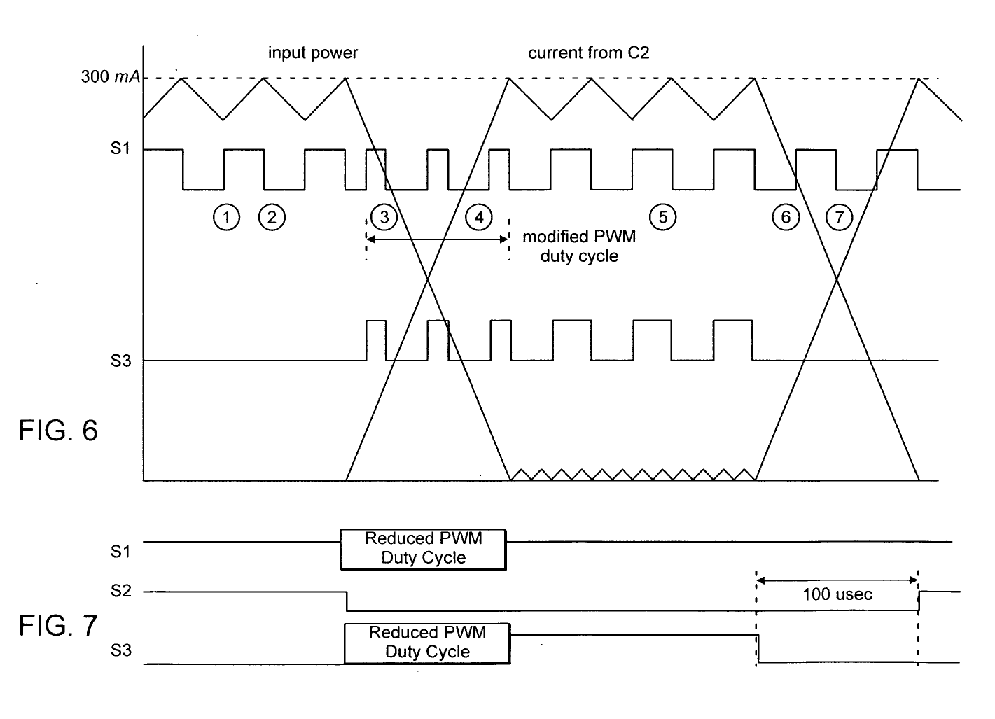

FIG. 6 is a signal diagram illustrating signals at various stages of an input line power interruption according to an embodiment or the present invention. Initially, the current from the line input power provides a current of approximately 300 mA to the DC/DC converter. During a normal operation (stage 1), switch S1 switches at a normal duty cycle to convert a Vᵢₙ converted to regulated Vₒᵤₜ for use by the ONU. In addition, an alternate power supply is charged from the Vₒᵤₜ using a Buck-Boost converter (stage 2). While the line input power is operating under normal condition, no current is supplied to the ONU from the alternate power supply.

However, when an interruption to the line input power occurs, a comparator or some other sensor may detect that failure (stage 3). As the failure is detected, switch S1 begins to operate in a modified PWM cycle, as does switch S3 in the alternate power supply. The current supply begins to transition from the line input power to the alternate power supply, so that the total current remains at approximately 300 mA (stage 4).

The line input power from Switch S1 is eventually disconnected, and S3 provides the power supply to the system output (stage 5). During this period, the switching at S1 may be discontinued altogether, or as shown in FIG. 6, the switching may continue in synchronization with S3. Because only limited, or no line input power is available through S1, the continual switching has no adverse effect on the system. Further, the continued switching may simplify later transitions back to the line input power.

Once the comparator or other sensing device detects the return of the line input power (stage 6), a transition from the alternate supply power to the line input power begins. Switch S1 switches continuously, providing current to the system output to the ONU. Once the current provided through the input line power is at a sufficiently high level, the current provided from the alternate power supply is discontinued.

FIG. 7 is diagram illustrating the switching operation of a system corresponding to the signal diagram illustrated in FIG. 6. As shown in FIG. 7, switch S1 continues to operate in a normal PWM cycle throughout operation, with the exception of the transition period to the alternate power source. During the transition period, S1 operates at a reduced PWM duty cycle. Similarly, while the line input provides power, S2 is switched on in order to allow the system to boost power into a storage capacitor in the alternate power source. When the line input power drops, S2 is switched off to allow the alternate power source to provide the appropriate output voltage to the operate the ONU. During the transition period where S2 is switched off and S1 operates at a reduced PWM duty cycle, S3 also operates at a reduced PWM duty cycle until it takes over completely. Once it take over the power supply, S3 operates at a normal PWM cycle. One line input power resumes, S3 discontinues switching. Shortly thereafter, after the regulated output has stabilized, S2 switches on to charge the alternate power source.

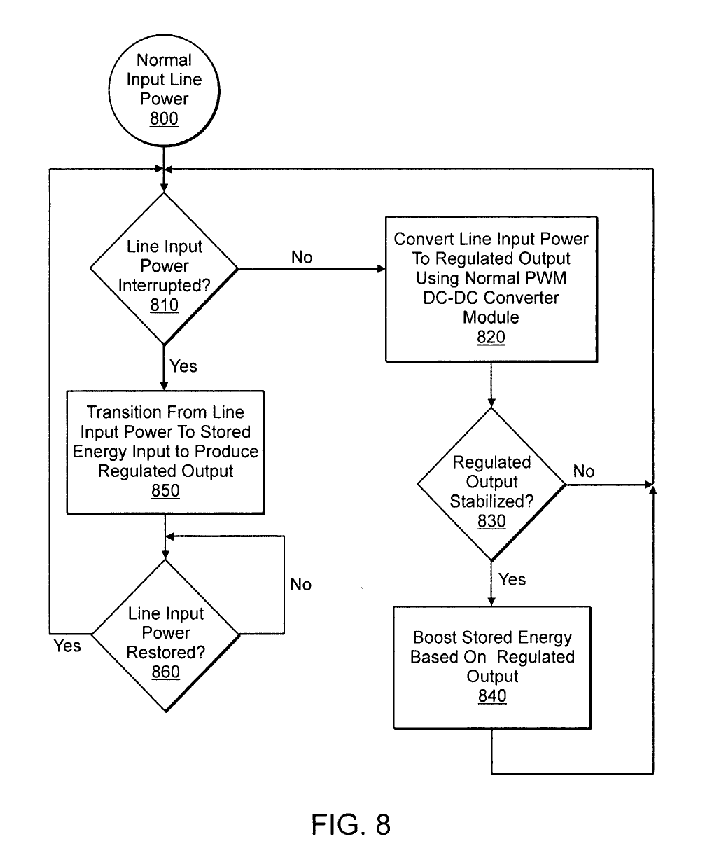

FIG. 8 is a flow chart that illustrates a method of storing and providing energy according to principles of the present invention. During normal operation 800, input line power is provided by an upstream power supply. At an ONU, some form of logic, such as a controller or comparator, will measure the line input to determine whether the line input power has been interrupted 810. If there is no interruption, the line input power will be converted to a regulated output using the normal PWM DC-DC converter module 820.

A controller also continually monitors the regulated output 830 to determine whether the output is stabilized. If the regulated output is stabilized, then the system will boost stored energy to the alternate power source based on the regulated output 840, and the line input power will continue to be monitored for interruption 801. If the regulated output is not stabilized, then no energy is boosted to the alternate power source, and the line is monitored for interruption 810.

If the line input power has been interrupted, the system begins a transition from the regulated output from the line input power, to a regulated output from the stored energy in the alternate power source 850. The line input power is monitored 860 to determine whether it has been restored.

While this invention has been particularly shown and described with references to example embodiments thereof, it will be understood by those skilled in the art that various changes in form and details may be made therein without departing from the scope of the invention encompassed by the appended claims.

What is claimed is:

1. An energy storage system comprising:
a pulse width modulation (PWM) DC-DC converter module configured to convert line input to a first regulated output at an output terminal;
a pump storage module coupled to the PWM DC-DC converter module at the output terminal and configured to store energy from energy of the first regulated output and convert the stored energy to a second regulated output;
logic coupled to the converter module and pump storage module configured to cause the converter module and pump storage module to transition power at the output terminal from the first regulated output power to the second regulated output in an event of interruption in the line input.

2. A system of claim 1 wherein the converter module includes a PWM controller configured to regulate the first regulated output of the PWM converter module by sensing input current and the first regulated output.

3. A system of claim 2 wherein the PWM controller is configured to control the pump storage module to convert the stored energy to the second regulated output.

4. A system of claim 2 further wherein the PWM controller controls both converter and module during transition of the power at the output terminal in an event of interruption in the line input.

5. A system of claim 1 wherein the logic if further configured to cause the converter module and pump storage module to transition power from the second regulated output to the output terminal to during a peak load period.

6. A system of claim 1 wherein the logic unit is further configured to soft start the pump storage module to ramp the stored energy to the second regulated output.

7. A system of claim 1 wherein the logic includes a monitoring unit configured to monitor the stored energy and adjust the stored energy on an as needed basis.

8. A system of claim 1 wherein the logic is a field programmable gate array (FPGA).

9. A system of claim 1 wherein the pump storage module circuit components are substantially the same as the converter circuit components as viewed from the output terminal.

10. A system of claim 1 further comprising a comparator coupled to the line input and a reference voltage, the comparator configured to detect and notify the logic of an interruption in the line input based on a comparison with the reference voltage.

11. A system of claim 1 wherein the PWM converter module includes an input capacitor capable of withstanding a voltage surge due to lightening.

12. A system of claim 1 wherein the line input to the PWM converter module is coupled to an upstream power supply absent a current limiter circuit.

13. A method of storing and providing energy, the method comprising:
converting line input power to a first regulated output at an output terminal;
storing energy from energy of the first regulated output at a storage module;
converting the stored energy to a second regulated output;
transitioning power at the output terminal from the first regulated output power to the second regulated output power in an event of interruption in the line input power.

14. A method of claim 13 further comprising regulating the first regulated output voltage of a PWM converter module by sensing input current and the first regulated output.

15. A method of claim 14 further comprising controlling the converting the stored energy to the second regulated output occurs with a PWM controller.

16. A method of claim 14 further comprising controlling both the first regulated output and the second regulated output during transitioning power at the output terminal in an event of interruption in the line input power.

17. A method of claim 13 wherein transitioning at the output terminal from the first regulated output power to the second regulated output power occurs during a peak load period.

18. A method of claim 13 further comprising ramping the stored energy to the second regulated output with a soft start.

19. A method of claim 13 further comprising monitoring the stored energy and adjust the stored energy on an as needed basis.

20. A method of claim 13 wherein transitioning power at the output terminal occur is controlled by a field programmable gate array (FPGA)

21. A method of claim 13 further comprising comparing a line input and a reference voltage to detect that the input line power is interrupted.

22. An energy storage system comprising:
means for converting line input power to a first regulated output at an output terminal;
means for storing energy from energy of the first regulated output;
means for converting the stored energy to a second regulated output;
means for causing the converter module and pump storage module to transition power at the output terminal from the first regulated output power to the second regulated output power in an event of interruption in the line input power.
